(19) United States
(12) Patent Application Publication
(10) Pub. No.: US 2022/0341112 A1
(43) Pub. Date: Oct. 27, 2022

(54) PILE CLAMP FOR SUSPENDING A WAVE-ATTENUATING DISK ABOVE A FLOOR OF A BODY OF WATER

(71) Applicants: Randall Arthur Boyd, Raleigh, NC (US); Mark Emmet Cooney, Raleigh, NC (US)

(72) Inventors: Randall Arthur Boyd, Raleigh, NC (US); Mark Emmet Cooney, Raleigh, NC (US)

(21) Appl. No.: 17/236,664

(22) Filed: Apr. 21, 2021

(51) Int. Cl. E02B 3/08; F16M 13/02

(52) U.S. Cl. CPC E02B 3/08; F16M 13/02

(57) ABSTRACT

A pile clamp can suspend at least one wave-attenuating disk from a floor of a body of water. The pile clamp can include a first curved element and a second curved element. The first curved element can include at least one opening for receiving a mechanical coupling component. The second curved element can include at least one opening for receiving the mechanical coupling component to couple to the first curved element to the second curved element and to a pile of a wave-attenuating pile assembly to suspend the wave-attenuating disk above a floor of a body of water.

### TECHNICAL FIELD

The present disclosure relates generally to wave attenuation devices and assemblies, and more particularly (but not exclusively), to pile assemblies for retaining wave attenuation devices and assemblies.

### BACKGROUND

Wave energy—that is, energy from water waves—can reach beaches and can cause beach erosion. Beach erosion can reduce the size of a beach by causing material, such as rock or sand, to be transported away from the beach. Beach erosion can also carry negative impacts further than the beach. For example, some communities can include beachfront properties that can be structurally, or otherwise, threatened by beach erosion. And, beach erosion can cause flooding that can damage or destroy coastal roads and coastal structures. Combatting beach erosion can include beach nourishment and other expensive methods that can involve depositing material on beaches to replace sand or other material lost due to beach erosion. The methods may be short-term or otherwise ineffective solutions since the methods address results of beach erosion and may not address wave energy deposited at the beaches or other causes of beach erosion.

### SUMMARY

In some examples, a pile clamp can suspend at least one wave-attenuating disk from a floor of a body of water. The pile clamp can include a first curved element and a second curved element. The first curved element can include at least one opening for receiving a mechanical coupling component. The second curved element can include at least one opening for receiving the mechanical coupling component to couple to the first curved element to the second curved element and to a pile of a wave-attenuating pile assembly to suspend the wave-attenuating disk above a floor of a body of water.

In other examples, a method can include positioning a first curved element of a pile clamp and a second curved element of the pile clamp around a pile of a wave-attenuating pile assembly. The first curved element and the second curved element can include at least one opening. The first curved element can abut the second curved element, and the first curved element and the second curved element can abut the pile. The method can additionally include mechanically coupling the first curved element to the second curved element and to the pile using a mechanical coupling component. The mechanical coupling component can be positioned within the at least one opening for suspending at least one wave-attenuating disk of the wave-attenuating pile assembly above a floor of a body of water.

In other examples, a pile system can include a pile, at least one wave-attenuating disk, and a pile clamp. The pile can be positioned in a body of water, and the wave-attenuating disk can be positioned around the pile. The pile clamp can be positioned around the pile, and the pile clamp can include a first curved element and a second curved element. The first curved element and the second curved element can include at least one opening for receiving a mechanical coupling component. The mechanical coupling component can couple the first curved element to the second curved element and to the pile to suspend the at least one wave-attenuating disk above a floor of a body of water.

### BRIEF DESCRIPTION OF DRAWINGS

FIG. 1 is a side, schematic view of a wave-attenuating pile assembly positioned in a body of water according to one example of the present disclosure.

FIG. 2 is an example of a side, schematic view and of a top-view of a set of wave-attenuating pile assemblies positioned on a floor of a body of water according to one example of the present disclosure.

FIG. 3 is a side, schematic view of a wave-attenuating pile assembly according to one example of the present disclosure.

FIG. 4 is a cross-section of a pile of a wave-attenuating pile assembly according to one example of the present disclosure.

FIG. 5 is a side-view of a curved element of a pile clamp according to one example of the present disclosure.

FIG. 6 is a cross-sectional side-view of a curved element of a pile clamp according to one example of the present disclosure.

FIG. 7 is a perspective view of a non-metallic disk of a wave-attenuating disk according to one example of the present disclosure.

FIG. 8 is a sectional top-view of a non-metallic disk of a wave-attenuating disk according to one example of the present disclosure.

FIG. 9 is an example of two side-views of a non-metallic disk and of a bottom disk of a wave-attenuating disk according to one example of the present disclosure.

FIG. 10 is an example of two views of a bushing of a wave-attenuating pile assembly according to one example of the present disclosure.

FIG. 11 is a flow chart of a process to suspend at least one wave-attenuating disk of a wave-attenuating pile assembly above a floor of a body of water according to one example of the present disclosure.

FIG. 12 is a flow chart of a process to position at least one wave-attenuating disk on a pile of a wave-attenuating pile assembly for attenuating waves according to one example of the present disclosure.

FIG. 13 is a flow chart of a process to attenuate waves of a body of water using a wave-attenuating disk that is suspended above a floor of the body of water according to one example of the present disclosure.

### DETAILED DESCRIPTION

Certain aspects and features relate to a wave-attenuating pile assembly that can be positioned on a floor of a body of water to attenuate, or otherwise reduce energy of, waves within the body of water. The wave-attenuating pile assembly can include a pile, a pile clamp, and at least one wave-attenuating disk. The pile can be a cylindrical rod, or other suitable shape, that can include metallic or non-metallic material. The pile can be embedded in the floor of the body of water for positioning the wave-attenuating disks above the floor of the body of water. The pile clamp can include one or more curved elements that can include non-metallic material and that can conform to the pile. The pile clamp can be positioned around the pile for suspending the wave-attenuating disk above the floor of the body of water. The wave-attenuating disk can include a non-metallic disk and a set of stone that can be positioned on the non-metallic disk. The wave-attenuating disk can be positioned around the pile and on a top-surface of the pile clamp to be suspended above the floor of the body of water. The wave-attenuating disk, while suspended above the floor of the body of water, can attenuate, or otherwise reduce energy of, waves within the body of water. In some examples, the wave-attenuating disk can attenuate the waves by physically obstructing the waves before the waves reach a shoreline. The wave-attenuating disk can reflect waves, or wave energy carried by the waves, by obstructing the waves using concrete, stone, wildlife attached to the stone, or other suitable mechanism for reflecting the waves or wave energy.

The wave-attenuating pile assembly can include one pile, one pile clamp, and one wave-attenuating disk. In some examples, the wave-attenuating pile assembly can include more than one pile, more than one pile clamp, more than one wave-attenuating disk, or a combination thereof. The wave-attenuating pile assembly can be included in a system that includes one or more wave-attenuating pile assemblies. In some examples, the system can include one wave-attenuating pile assembly, but in other examples, other suitable amounts of wave-attenuating pile assemblies can be included in the system for attenuating the waves. In examples in which the system includes more than one wave-attenuating pile assembly, the wave-attenuating pile assemblies can be mechanically coupled via a c-channel that can increase lateral load capacity of the system.

The system can be positioned on the floor of the body of water for attenuating, or otherwise reducing energy, of the waves of the body of water. In some examples, the system can attenuate the waves such that the waves do not reach a shoreline of the body of water. In other examples, the system may attenuate, or otherwise reduce energy of, the waves such that the waves deposit less energy at the shoreline of the body of water. The system can be characterized by various porosity, permeability, and wave-attenuation values or by other suitable measures. For example, a decrease in permeability can indicate an increase in wave-attenuation ability of the system. In some examples, reducing energy deposited at the shoreline of the body of water may reduce or halt progression of beach erosion that occurs at the shoreline and can extend or improve beach nourishment.

In examples in which the wave-attenuating pile assembly includes more than one wave-attenuating disk, the wave-attenuating pile assembly can include a bottom wave-attenuating disk and at least one wave-attenuating disk. The bottom wave-attenuating disk can include a bottom disk that may be different in size, shape, or other measure from the non-metallic disk of the at least one wave-attenuating disk. For example, the bottom disk may be characterized by a thickness that is greater than a thickness of the non-metallic disk. The bottom wave-attenuating disk can distribute a load, which can include tension and compression, of the non-metallic disks to the pile clamp. As such, the bottom wave-attenuating disk may include additional reinforcing components, such as reinforcing bars, compared to the wave-attenuating disks. Additionally or alternatively, the non-metallic disk may include at least one setting element for stacking the non-metallic disk on the bottom wave-attenuating disk or an additional wave-attenuating disk. In some examples, the bottom disk does not include the setting element. In those examples, the bottom disk may have a smooth bottom surface for positioning the bottom wave-attenuating disk on a top surface of the pile clamp. The bottom wave-attenuating disk and the wave-attenuating disk can include a set of stone, such as calcite-containing stone, for causing the wave-attenuating pile assembly to resemble or otherwise function similar to a natural reef. For example, the wave-attenuating disk can attract or otherwise develop aquatic wildlife in similar mechanisms compared to natural reefs.

The pile clamp may include a first curved element and a second curved element. Other suitable amounts of curved elements can be included in the pile clamp to suspend the at least one wave-attenuating disk from a floor of the body of water. The first curved element and the second curved element can include at least one opening for receiving a mechanical coupling component. In some examples, the first curved element and the second curved element can include suitable amounts of openings for allowing the first curved element and the second curved element to be coupled to the pile. The first curved element and the second curved element can, in response to being coupling, form or otherwise include a top surface that can be characterized by an outer diameter that is greater than an inner diameter of a wave-attenuating disk. In some examples, the bottom wave-attenuating disk may be characterized by an inner diameter that is less than the outer diameter of the top surface to allow the bottom wave-attenuating disk to be positioned on the top surface to suspend at least the bottom wave-attenuating disk from the floor of the body of water.

The pile can be characterized by an outer diameter and an inner diameter in which the outer diameter is similar or identical to an inner diameter of the pile clamp, the wave-attenuating disk, or a combination thereof. The pile can resemble a cylindrical shell that can be characterized by an optimized thickness. The thickness may be a different between the outer diameter and the inner diameter. The thickness may be optimized for strength, load, or other, suitable, optimal measures. The pile may be driven into or otherwise embedded in a floor of the body of water to a suitable distance for retaining the wave-attenuating pile assembly in place for attenuating the waves. In some examples, the system can include wave-attenuating pile assemblies that include piles that are embedded in the floor different amounts of distances.

In some examples, in response to embedding the pile in the floor of the body of water, the pile clamp can be coupled to the pile. The pile clamp can be mechanically coupled to the pile, can be adhesively coupled to the pile, a combination thereof or coupled to the pile in other suitable manners. A mechanical coupling component can be used to couple the pile clamp to the pile. Adhesive can be positioned on the inner diameter of the pile clamp for adhesively coupling the pile clamp to the pile. In response to coupling the pile clamp to the pile, a wave-attenuating disk can be positioned on an upper surface of the pile clamp. In some examples, a lifting machine can lift the wave-attenuating disk and place the wave-attenuating disk around the pile and on the pile clamp such that the pile extends through the inner diameter of the wave-attenuating disk. In some examples, the wave-attenuating disk can be a bottom wave-attenuating disk that includes a bottom disk that is different from that of different wave-attenuating disks. In some examples, a bushing can be positioned between a wave-attenuating disk and the pile, or around the pile and proximate to the wave-attenuating disk, for reducing abrasion to the pile, friction from the pile, motion, vibration, or a combination thereof of the wave-attenuating pile assembly.

In some examples, additional wave-attenuating disks can be positioned around the pile and on the wave-attenuating disk for increasing efficacy or efficiency of wave attenuation. In response to positioning a last wave-attenuating disk around the pile and on the upper surface of the pile clamp or on an additional wave-attenuating disk, a top clamp can be positioned around the pile and on an upper surface of the last wave-attenuating disk. The top clamp can be similar or identical to the pile clamp and can reduce motion or encountered force of the wave-attenuating pile assembly or the wave-attenuating disk.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

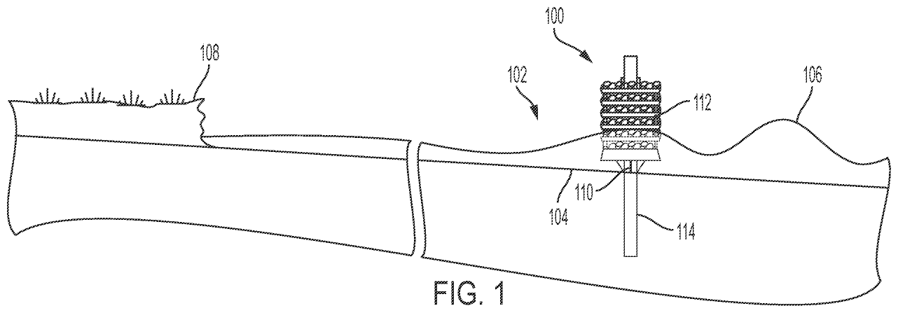

FIG. 1 is a side-view of a wave-attenuating pile assembly 100 positioned in a body 102 of water according to one example of the present disclosure. The wave-attenuating pile assembly 100 may be positioned on a floor 104 of the body 102 of water for attenuating, or otherwise reducing energy of, waves 106. In some examples, the waves 106 may be traveling towards a shoreline 108 and may, otherwise with the absence of the wave-attenuating pile assembly 100, deposit wave energy at the shoreline 108. The wave-attenuating pile assembly 100 may reduce the deposited wave energy. The wave-attenuating pile assembly 100 may include a pile clamp 110, at least one wave-attenuating disk 112, a pile 114, and a bushing. In some examples, the wave-attenuating pile assembly 100 may include additional or alternative components for suspending the wave-attenuating disk 112 above the floor 104 of the body 102 of water for attenuating, or otherwise reducing energy of, the waves 106.

The pile 114 may be driven into, or otherwise embedded in, the floor 104. The pile clamp 110 may be positioned on or around the pile 114. The pile clamp 110 can be mechanically coupled to the pile 114, can be adhesively coupled to the pile 114, a combination thereof, or can be coupled to the pile 114 in other suitable manners. The pile clamp 110 may conform to ASTM D5421 and may be characterized by a minimum axial load of 210,000 lbs. The pile clamp 110, once positioned on the pile 114, can suspend the wave-attenuating disk 112 from the floor 104 of the body 102 of water. The wave-attenuating disk 112 can be positioned around the pile 114 and can be positioned on a top surface of the pile clamp 110. The wave-attenuating disk 112 may be characterized by an inner diameter that can be similar or identical to an outer diameter of the pile 114 and that can be less than an outer diameter of the top surface of the pile clamp 110. The wave-attenuating disk can include concrete or other suitable materials for constructing the wave-attenuating disk 112.

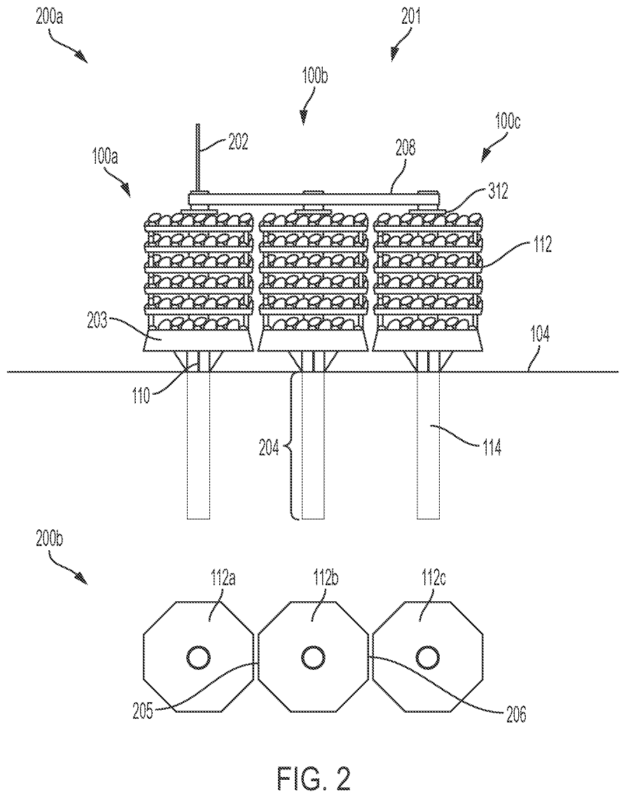

FIG. 2 is an example of a side, schematic view 200a and a top-view 200b of a set 201 of wave-attenuating pile assemblies 100a-c positioned on a floor 104 of a body 102 of water according to one example of the present disclosure. As illustrated in the view 200a, the set 201 includes three wave-attenuating pile assemblies 100, but in other examples, the set 201 can include other suitable numbers of wave-attenuating pile assemblies 100. The wave-attenuating pile assemblies 100 are illustrated configured in a straight line, but the wave-attenuating pile assemblies 100 can be arranged in other suitable configurations for attenuating the waves 106. The wave-attenuating pile assemblies 100 can include the pile clamp 110, the wave-attenuating disk 112, and the pile 114. In some examples, each wave-attenuating pile assembly 100 includes the pile clamp 110, the pile 114, and a set of the wave-attenuating disks 112. Suitable numbers of wave-attenuating disks 112 for attenuating, or otherwise reducing energy of, the waves 106 can be included in each wave-attenuating pile assembly 100. In some examples, the wave-attenuating pile assemblies 100 can include equal numbers of wave-attenuating disks 112. In other examples, wave-attenuating pile assemblies 100 can include unequal numbers of wave-attenuating disks 112. In some examples, the set 201 can include a navigational marker 202 that can be positioned on one or more of the wave-attenuating pile assemblies 100. Each wave-attenuating pile assembly 100a-c can include a top clamp 312. The top clamp 312 can be positioned around the pile 114 for preventing excessive or unnecessary motion by the wave-attenuating disks 112. The top clamp 312 can be similar or identical to the pile clamp 110. In some examples, the top clamp 312 can be a simple clamp that is mechanically coupled to the pile 114 of each wave-attenuating pile assembly 100a-c.

In some examples, the wave-attenuating pile assemblies 100 may include a bottom wave-attenuating disk 203 in addition to, or alternative to, the wave-attenuating disks 112. The bottom wave-attenuating disk 203 may be similar to the wave-attenuating disk 112 but may be characterized by a bottom non-metallic disk that is larger than or otherwise different than a non-metallic disk of the wave-attenuating disk 112. The bottom wave-attenuating disk 203 may include doubly-reinforced material compared to the wave-attenuating disk 112 for distributing the load of one or more wave-attenuating disks 112 to the pile clamp 110. The bottom wave-attenuating disk 203 may be positioned around the pile 114 and on the pile clamp 110 for suspending at least the bottom wave-attenuating disk 203 from the floor 104 of the body 102 of water. In some examples, additional wave-attenuating disks 112 can be positioned on the bottom wave-attenuating disk 203 for increasing wave-attenuation efficacy or increasing wave-attenuation efficiency. In some examples, the bottom wave-attenuating disk 203 can, similar to a natural reef, attract wildlife.

The pile 114 can be embedded in, or otherwise driven into, the floor 104 of the body 102 of water. A distance 204 that the pile 114 is embedded in the floor 104 can be determined by an engineer or other suitable individual, and the distance 204 may be determined by using a depth of the body 102 of water, a mean wave-energy of the waves 106, a composition of the floor 104, a combination thereof, or other suitable inputs. In some examples, each pile 114 of the set 201 of wave-attenuating pile assemblies 100 can be embedded in the floor an amount approximately equal to the distance 204. In other examples, each wave-attenuating pile assembly 100 may be embedded in the floor 104 a different or unique distance. In some examples, the wave-attenuating pile assemblies 100 can be mechanically coupled together using a c-channel 208. The c-channel 208 can include suitable materials, such as a composite, non-metallic material, for mechanically coupling the wave-attenuating pile assemblies 100 together. The c-channel 208 can be mechanically coupled to the wave-attenuating pile assemblies 100 on a top portion of each wave-attenuating pile assembly 100a-c. The c-channel 208 can increase the lateral load capacity of the wave-attenuating pile assemblies 100.

The view 200b illustrates a top-view of the set 201 of the wave-attenuating pile assemblies 100. The top-view may resemble wave-attenuating disks 112a-c that may correspond to the wave-attenuating pile assemblies 100a-c. Each wave-attenuating disk 112a-c may be similar or identical to a different wave-attenuating disk 112 of the wave-attenuating disks 112. The wave-attenuating disks 112 may be positioned on the pile 114 a predetermined distance 205 or 206 from one another. The distance 205 and the distance 206 may be similar or identical, but in other examples, the distance 205 and the distance 206 can be unique or otherwise different. As illustrated in the view 200b, the wave-attenuating disks 112 are octagonal, but other suitable shapes, such as square, hexagonal, heptagonal, or decagonal, can be used. In some examples, the shape of the wave-attenuating disks 112 may be optimized to maximize attenuation of waves and to minimize porosity and sediment transport through the wave-attenuating disks 112. Additionally or alternatively, the shape of the wave-attenuating disks 112 may mitigate or eliminate stress cracks in the wave-attenuating disks 112. The shape of the wave-attenuating disks 112 can include a chamfer of one or more portions of the wave-attenuating disks 112.

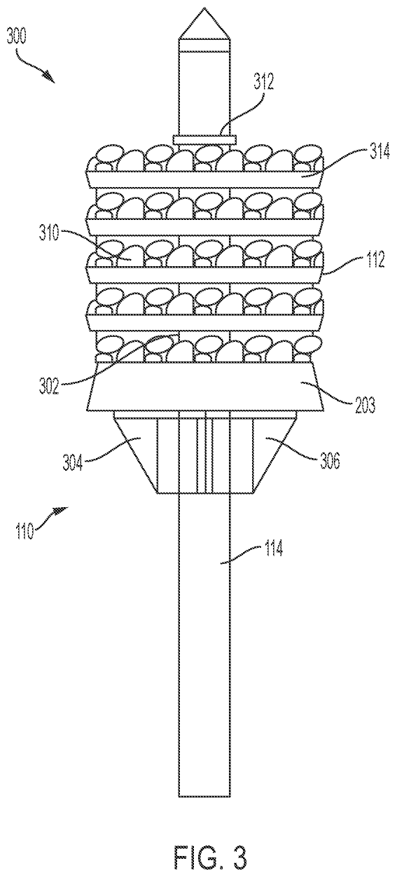

FIG. 3 is a side-view of a wave-attenuating pile assembly 300 according to one example of the present disclosure. In some examples, the wave-attenuating pile assembly 300 can be similar or identical to the wave-attenuating pile assembly 100 described with respect to FIGS. 1 and 2. The wave-attenuating pile assembly 300 can include the pile clamp 110, the wave-attenuating disk 112, the pile 114, and a bushing 302. As illustrated, the wave-attenuating pile assembly 300 includes four wave-attenuating disks 112 and a bottom wave-attenuating disk 203, but the wave-attenuating pile assembly 300 can include other suitable amounts of wave-attenuating disks 112 for attenuating the waves 106.

The pile clamp 110 can include a first curved element 304 and a second curved element 306. The first curved element 304 and the second curved element 306 can be similar or identical to one another and can be positioned around the pile 114. The first curved element 304 and the second curved element 306 can be characterized by an inner diameter that can be similar or identical to an outer diameter of the pile 114. The first curved element 304 and the second curved element 306 can be mechanically coupled to the pile 114 for suspending the wave-attenuating disk 112 above the floor 104. Additionally or alternatively, the first curved element 304 and the second curved element 306 can be adhesively coupled to the pile 114. In examples in which the element 304, or the element 306, is adhesively coupled to the pile 114, the element 304, or the element 306, may be mechanically coupled to the pile 114 for a predetermined amount of time to allow an adhesive to form a bond between the element 304, or the element 306, and the pile 114.

The wave-attenuating disk 112 can include a non-metallic disk that can include a non-metallic material such as a fiberglass-reinforced composite material, a polymer, concrete, or other suitable non-metallic material. In examples in which the non-metallic disk, or the bottom wave-attenuating disk 203, includes concrete, the concrete may be formulated with a marine concrete mix that can be characterized by a compression strength of minimum 4,000 PSI. In these examples, the concrete may conform to the North Carolina Department of Transportation Standard Specifications Section 1000. The non-metallic disk can be positioned at approximately a bottom portion of the wave-attenuating disk 112. The wave-attenuating disk 112 can additionally include stone 310 that can be positioned on the non-metallic disk. The stone 310 can include biochemical rocks, such as limestone, granite, oyster shells, or other calcite-containing rock, for allowing the wave-attenuating pile assembly 300 to function as an artificial reef. For example, wildlife such as coral or other suitable wildlife can attach to the stone 310 and can grow on the wave-attenuating disk 112 in a similar manner compared to a naturally occurring reef. In some examples, the wave-attenuating pile assembly 300 can include the bottom wave-attenuating disk 203. The bottom wave-attenuating disk 203 may include non-metallic material and may be different in shape or size from the wave-attenuating disk 112. The bottom wave-attenuating disk 203 can be positioned on an upper surface of the pile clamp 110 for suspending the wave-attenuating disk 112 from the floor 104 of the body 102 of water. In some examples, additional wave-attenuating disks 112 can be positioned on the bottom wave-attenuating disk 203.

In some examples, the wave-attenuating pile assembly 300 can be rotated to allow flushing to occur. The wave-attenuating disks 112 can include one or more features that allow sediment to be flushed or to be captured based on a rotational angle of the wave-attenuating pile assembly 300. For example, rotating the wave-attenuating pile assembly 300 can flush, or otherwise remove, sediment that has been captured by the wave-attenuating disks 112. Additionally or alternatively, the wave-attenuating pile assembly 300 can include a top clamp 312 that can retain the wave-attenuating disks 112. For example, five wave-attenuating disks 112 can be positioned around the pile 114 and can be suspended from the floor 104 via the pile clamp 110. In this example, the top clamp 312 can be positioned around the pile 114 and on a top wave-attenuating disk 314 to prevent the wave-attenuating disks 112 from undergoing unnecessary motion or from encountering excessive force from the waves 106. The top clamp 312 can cause the wave-attenuating pile assembly 300 to attenuate the waves 106 more efficiently as compared to a wave-attenuating pile assembly that does not include the top clamp 312. In some examples, the top clamp 312 can be a simple or otherwise typical clamp. In other examples, the top clamp 312 can be similar or identical to the pile clamp 110. Additionally, the bushing 302 can be positioned around the pile 114 to reduce friction, vibration, motion, a combination thereof, or to optimize other suitable interactions between the pile 114 and the wave-attenuating disks 112 or the bottom wave-attenuating disk 203.

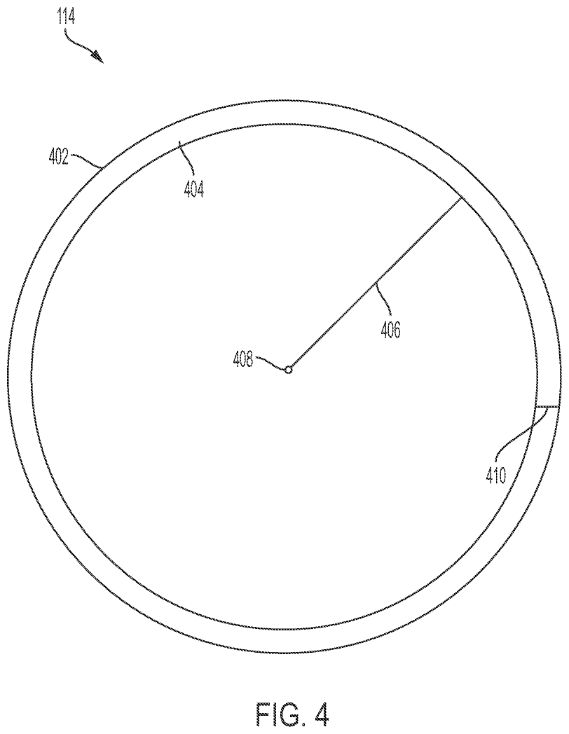

FIG. 4 is a cross-section of a pile 114 of a wave-attenuating pile assembly 300 according to one example of the present disclosure. The pile 114 can include material such as a fiberglass-reinforced composite material. In some examples, the fiberglass-reinforced composite material can include glass-fiber-reinforced thermosetting resin material or other, suitable, non-metallic material. The pile 114 can be a length determined by the engineer or other suitable individual or entity. The length of the pile 114 can be determined, in part, by an embedment distance, such as the distance 204, by an amount of wave-attenuating disks 112 that may be positioned on the pile 114, and by other suitable input information.

The pile 114 can be characterized by an outer diameter 402 and by an inner diameter 404. The outer diameter 402 can be similar or identical to an inner diameter of the wave-attenuating disk 112, to an inner diameter of the pile clamp 110, or to a combination thereof. The inner diameter 404 may be characterized by a distance 406 from the center 408 of the pile 114 to the inner diameter 404. In some examples, the distance 406 may be determined in part by optimizing a thickness 410 of the pile 114. The thickness 410 of the pile 114 may be considered optimized in examples in which the pile 114 is characterized by a flexural strength of at least 76,000 PSI, by an axial compression strength of at least 76,000 PSI, by a modulus of elasticity of at least 5,200,000 PSI, and by an allowable moment of at least 159 KIP-FT. In other examples, the thickness 410 of the pile can be optimized via other suitable measures.

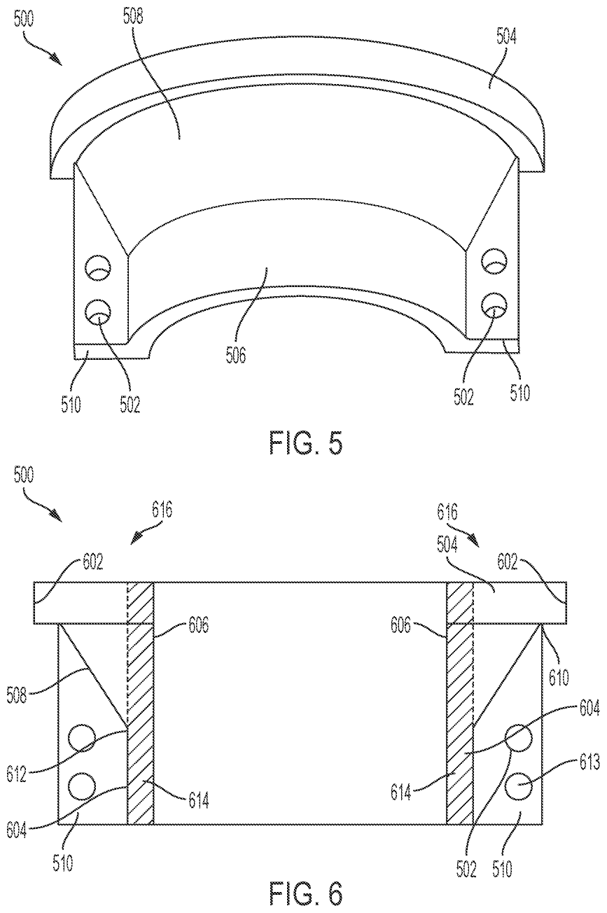

FIG. 5 is a side-view of a curved element 500 of a pile clamp 110 according to one example of the present disclosure. The pile clamp 110 may include two curved elements 500 such as the first curved element 304 and the second curved element 306. In some examples, the first curved element 304 and the second curved element 306 can be similar or identical. The pile clamp 110 may include other suitable amounts of curved elements 500 for suspending the wave-attenuating disk 112 above the floor 104.

The curved element 500 may include at least one opening 502 for receiving a mechanical coupling component for coupling the curved element 500 to an additional curved element 500, to the pile 114, or to a combination thereof. As illustrated, the curved element 500 includes four openings 502, but the curved element 500 may include other suitable amounts of openings 502 for receiving the mechanical coupling component to mechanically couple the curved element 500 to an additional curved element 500, to the pile 114, or to a combination thereof. The curved element 500 may additionally include a first ring 504, a second ring 506, a tapered region 508, and at least two wings 510. The openings 502 may be positioned on the wings 510 but can be positioned on other suitable components of the curved element 500. The first ring 504 may be positioned adjacent to the tapered region 508, and the tapered region 508 may be positioned adjacent to the second ring 506. The tapered region 508 may be positioned between the first ring 504 and the second ring 506. The tapered region 508 may be characterized by a decreasing outer diameter from the first ring 504 to the second ring 506. The wings 510 may be positioned adjacent to the first ring 504, the second ring 506 and the tapered region 508 such that the wings 510 and the second ring 506, and the wings 510 and the tapered region 508, form a right angle. A width of the wings 510 may be constant along a region of the wings 510 adjacent to the second ring 506. The width of the wings 510 may be constant and decreasing along a region of the wings 510 adjacent to the tapered region 508. A minimum width of the wings 510 can be adjacent to the first ring 504, and a maximum width of the wings 510 can be adjacent to the second ring 506.

FIG. 6 is a cross-sectional side-view of the curved element 500 of the pile clamp 110 according to one example of the present disclosure. The curved element 500 can include the first ring 504, the second ring 506, the tapered region 508, the wings 510, and the openings 502. As illustrated, the curved element 500 additionally includes a first outer diameter 602, a second outer diameter 604, and an inner diameter 606. The first ring 504 can be characterized by the first outer diameter 602 and by the inner diameter 606. The second ring 506 can be characterized by the second outer diameter 604 and by the inner diameter 606. The tapered region 508 can be characterized by the inner diameter 606 and by a tapered outer diameter 608. In some examples, the tapered outer diameter 608 can constantly decrease, in which a slope of the tapered outer diameter 608 is constant and negative, from a first position 610 abutting the first ring 504 to a second position 612 abutting the second ring 506.

The curved element may additionally include at least one mechanical coupling component 613 that can be positioned in the opening 502. In some examples, the mechanical coupling component 613 can be positioned within the opening 502 to mechanically couple the first curved element 304 to the second curved element 306 and to the pile 114. The inner diameter 606 may be similar or identical to the outer diameter 402 of the pile 114. The inner diameter 606 may include an adhesive region 614 that includes an adhesive for adhesively coupling the curved element 500 to the outer diameter 402 of the pile 114. In some examples, the adhesive region 614 may coincide with the inner diameter 606. In other examples, the adhesive region 614 may be applied to the inner diameter 606 as a top-layer of the inner diameter 606. The adhesive region 614 may, in response to positioning the curved element 500 adjacent to the pile 114, form a bond with the pile 114 for adhesively coupling the curved element 500 to the pile 114. In some examples, the curved element 500 can be mechanically coupled to the pile 114 for a predetermined amount of time to allow the bond to be formed to adhesively couple the curved element 500 to the pile 114. In some examples, the adhesive can be etched into a surface of the adhesive region 614 or of the pile 114.

The curved element 500 may additionally include a top, or an upper, surface 616. The upper surface 616 may resemble a ring and may be characterized by the first outer diameter 602 and by the inner diameter 606. In some examples, the first outer diameter 602 of the upper surface 616 can be greater than an inner diameter of the wave-attenuating disk 112. The wave-attenuating disk 112, or the bottom wave-attenuating disk 203, can be positioned on the upper surface 616 for suspending the wave-attenuating disk 112, the bottom wave-attenuating disk 203, or a combination thereof above the floor 104 of the body 102 of water.

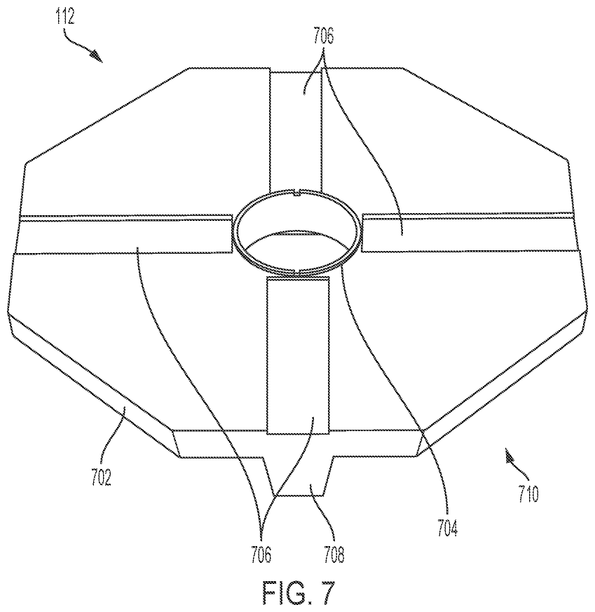

FIG. 7 is a perspective view of the non-metallic disk of the wave-attenuating disk 112 according to one example of the present disclosure. The non-metallic disk may include non-metallic material such as a polymer, concrete, fiberglass-reinforced composite material, or other suitable non-metallic material. The non-metallic disk can be characterized by an outer surface 702, an inner diameter 704, and a set of indents 706. The outer surface 702 may resemble a hexagon, an octagon, a circle, or other suitable shape for the non-metallic disk of the wave-attenuating disk 112. In some examples, the inner diameter 704 may be similar or equal to the inner diameter 606 of the pile clamp 110, to the outer diameter 402 of the pile 114, or a combination thereof. In other examples, a sum of the inner diameter 704 and of a thickness of the bushing 302 can be similar or equal to the inner diameter 606 of the pile clamp 110, to the outer diameter 402 of the pile 114, or a combination thereof. The indents 706 can receive a setting element 708 from an additional non-metallic disk from an additional wave-attenuating disk 112. A cross-section of the indents 706 can resemble rectangles, squares, ellipses, or other suitable shapes for receiving the setting element 708.

The non-metallic disk may additionally include the setting element 708 that can be positioned on a bottom surface 710 of the non-metallic disk. The setting element 708 may be an equal and opposite shape compared to the indents 706 such that the setting element 708 fits into the indents 706. For example, if the indents 706 represent concave rectangular prisms, then the setting element 708 may represent a convex rectangular prism to allow the setting element 708 to fit in the indents 706 for stacking a set of wave-attenuating disks 112. The wave-attenuating disk 112 may additionally include the stone 310 positioned on the non-metallic disk for increasing wave-attenuation efficacy or wave-attenuation efficiency. The stone 310 may additionally cause or otherwise allow the wave-attenuating pile assembly 300 to resemble or function similar to a naturally occurring reef.

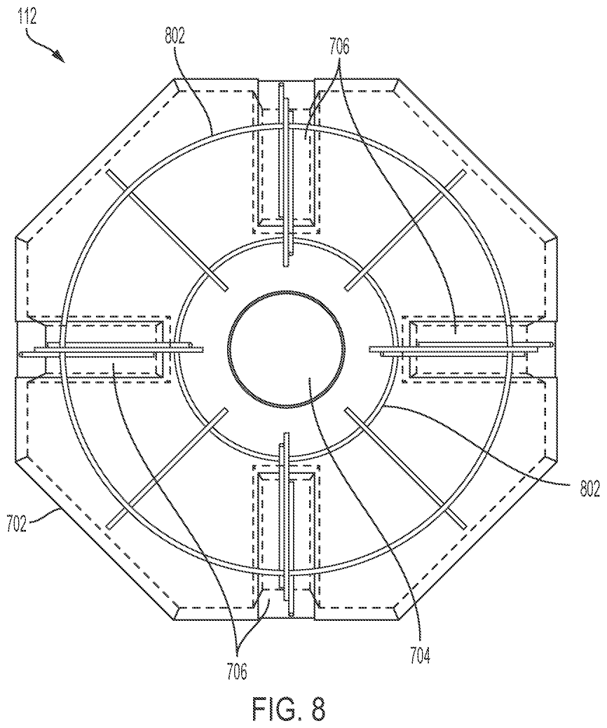

FIG. 8 is a sectional top-view of the wave-attenuating disk 112 according to one example of the present disclosure. The wave-attenuating disk 112 can include the outer surface 702, the inner diameter 704, and the set of indents 706. The wave-attenuating disk 112 can additionally include reinforcing bars 802 that can be positioned in various locations within the wave-attenuating disk 112. As illustrated, the reinforcing bars 802 are positioned in a wheel-and-spoke pattern within the wave-attenuating disk 112, but the reinforcing bars 802 can be arranged in other suitable manners for reinforcing the wave-attenuating disk 112. The reinforcing bars 802 can include polymer rebar, glass-fiber-reinforced thermosetting resin, or other suitable material for increasing strength or performance of the wave-attenuating disk 112. In some examples, the reinforcing bars 802 can include a glass-fiber-reinforced polymer rebar to optimize tensile and compressive strength of the wave-attenuating disk 112. The glass-fiber-reinforced polymer rebar may obviate the use of corrosion-inhibitors in concrete present in the wave-attenuating disk 112. In some examples, the reinforcing bars 802 may be characterized by a tensile strength of at least 148 KSI, which may conform to ASTM D7205. In other examples, the reinforcing bars 802 may be characterized by a nominal tensile modulus of at least 7246 KSI, which may conform to ASTM D7205. The reinforcing bars 802 may additionally be characterized by an effective cross-sectional area of about 0.23 in but may be characterized by other suitable effective cross-sectional areas for reinforcing the wave-attenuating disk 112.

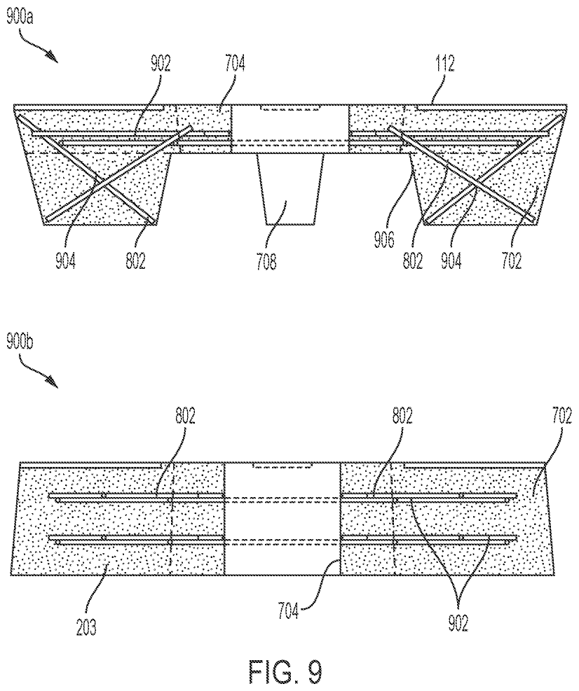

FIG. 9 is an example of two side-views 900a-b of the wave-attenuating disk 112 and of a bottom wave-attenuating disk 203 according to one example of the present disclosure. The side-view 900a illustrates the wave-attenuating disk 112, and the side-view 900b illustrates the bottom wave-attenuating disk 203. The wave-attenuating disk 112 and the bottom wave-attenuating disk 203 may be characterized by the inner diameter 704. The wave-attenuating disk 112 and the bottom wave-attenuating disk 203 may include the indent 706 for receiving the setting element 708. A similar or identical amount of the stone 310 may be positioned on the wave-attenuating disk 112 and on the bottom wave-attenuating disk 203 for attenuating the waves 106. And, the wave-attenuating disk 112 and the bottom wave-attenuating disk 203 may include reinforcing bars 802 that include similar or identical material. But, the reinforcing bars 802 may be arranged within the wave-attenuating disk 112 differently than in the bottom wave-attenuating disk 203. For example, the wave-attenuating disk 112 may include reinforcing bars 802 in one ring 902 arrangement and various cross 904 arrangements. In contrast, the bottom wave-attenuating disk 203 may include reinforcing bars 802 in two of the ring 902 arrangements.

Additionally, the wave-attenuating disk 112 and the bottom wave-attenuating disk 203 may be characterized by the outer surface 702. But, the outer surface 702 of the wave-attenuating disk 112 may be different than the outer surface 702 of the bottom wave-attenuating disk 203. For example, the outer surface 702 of the wave-attenuating disk 112 may resemble a hexagon, an octagon, a decagon, or other similar shape, while the outer surface 702 of the bottom wave-attenuating disk 203 may be an outer diameter such that the outer surface 702 of the bottom wave-attenuating disk 203 resembles a circle. The wave-attenuating disk 112 may include the setting element 708 that can allow the wave-attenuating disk 112 to be positioned on the indent 706 of the bottom wave-attenuating disk 203 or on the indent 706 of an additional wave-attenuating disk 112. A leg 906 of the wave-attenuating disk 112 can be extended toward the setting element 708. For example, a distance between the leg 906 and the setting element 708 can be variable and can be minimized or otherwise optimized for optimizing wave-attenuation of the wave-attenuating disk 112.

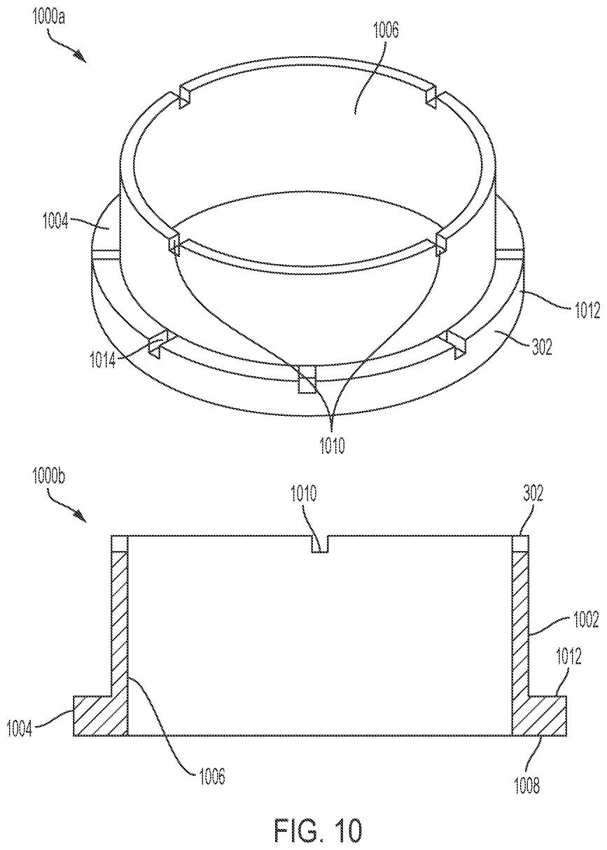

FIG. 10 is an example of two views 1000a-b of a bushing 302 of a wave-attenuating pile assembly 300 according to one example of the present disclosure. The view 1000a illustrates a perspective view of the bushing 302, and the view 1000b illustrates a cross-sectional side-view of the bushing 302. The bushing 302 can be characterized by a first outer diameter 1002, a second outer diameter 1004, an inner diameter 1006, a bottom surface 1008, at least one notch 1010, a top surface 1012, and at least one rebar seat 1014. The first outer diameter 1002 may be smaller than the second outer diameter 1004. Additionally or alternatively, the first outer diameter 1002 may be similar or identical to the inner diameter 704 of the wave-attenuating disk 112. In some examples, the inner diameter 1006 may be similar or identical to the outer diameter 402 of the pile 114. The bottom surface 1008 may resemble a ring that can be characterized by the inner diameter 1006 and the second outer diameter 1004. As illustrated, the bushing 302 includes four notches 1010, but other suitable amounts of notches 1010 can be included in the bushing 302. The top surface 1012 may resemble a ring that can be characterized by the first outer diameter 1002 and the second outer diameter 1004. In some examples, the bushing 302 can be an anchor for the reinforcing bars 802. The rebar seat 1014 can resemble a notch in the second outer diameter 1004 and can be sized to receive one or more reinforcing bars 802 of the wave-attenuating disk 112 or of the bottom wave-attenuating disk 203. In some examples, rebar seats 1014 can be positioned every 45 degrees along the second outer diameter 1004. The rebar seats 1014 can be positioned in other suitable arrangements for seating the reinforcing bars 802.

The bushing 302 can include non-metallic material such as polymer, fiberglass-reinforced composite material, or other suitable non-metallic material. In some examples, the bushing can include toluene diisocyanate polyether polyurethane. The bushing 302 can be characterized by a tensile strength of at least 6,800 PSI, a hardness of at least 60 shore d durometer units, a 100% modulus of at least 2,690 PSI, an elongation of at least 366%, and a specific gravity of at least 1.16. In some examples, the bushing 302 may be characterized by increased or otherwise improved resistance to salt water, UV radiation, Ozone, and oxidation compared to metallic bushings or to bushings composed of different material.

The bushing 302 can function as an anti-abrasion collar. For example, the bushing 302 can be positioned such that the first outer diameter 1002 is adjacent to the inner diameter 704 of the wave-attenuating disk 112 and such that the inner diameter 1006 is adjacent to the outer diameter 402 of the pile 114. In this example, any rotation of the wave-attenuating disk 112 with respect to the pile 114 may not cause damage to the pile 114 and may extend the functional lifetime of the wave-attenuating pile assembly 300. In other examples, the bushing 302 may additionally be positioned such that the top surface 1012 is adjacent to, or otherwise resting on, a top surface of the wave-attenuating disk 112 or of the bottom wave-attenuating disk 203. In these examples, the bottom surface 1008 may be positioned such that a normal to the bottom surface 1008 is directed upward. In some examples, more than one bushing 302 can be positioned around or on the pile 114. In examples in which more than one bushing 302 is positioned around or on the pile 114, the amount of bushings 302 of the wave-attenuating pile assembly 300 may be equal to the amount of a combination of wave-attenuating disks 112 and the bottom wave-attenuating disk 203 positioned around or on the pile 114. In these examples, each bushing 302 positioned around or on the pile 114 may additionally be positioned such that the top surface 1012 of each bushing 302 is adjacent to a top surface of a different wave-attenuating disk 112 or the bottom wave-attenuating disk 203. Additionally or alternatively, the bottom surface 1008 of one bushing 302 may support an additional bushing 302, the wave-attenuating disk 112, a combination thereof, or other suitable component.

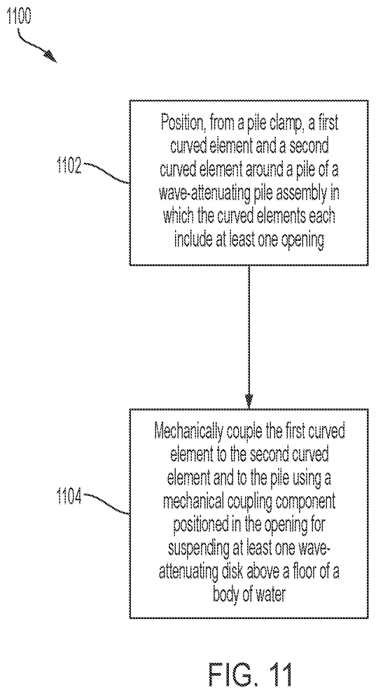

FIG. 11 is a flow chart of a process 1100 to suspend at least one wave-attenuating disk 112 of a wave-attenuating pile assembly 300 above the floor 104 of the body 102 of water according to one example of the present disclosure. At block 1102, a first curved element 304 and a second curved element 306 are positioned around the pile 114 of the wave-attenuating pile assembly 300. The first curved element 304 and the second curved element 306 may be similar or identical to the curved element 500 described with respect to FIGS. 5 and 6. The first curved element 304 and the second curved element 306 may include at least one opening 502 that can receive the mechanical coupling component 613 for coupling the first curved element 304 and the second curved element 306 to the pile 114.

At block 1104, the first curved element 304 is coupled to the second curved element 306 and to the pile 114 using the mechanical coupling component 613. In response to positioning the first curved element 304 and the second curved element 306 around the pile 114, the first curved element 304 can be mechanically coupled to the second curved element 306 and to the pile 114 to suspend at least one wave-attenuating disk 112 above the floor 104 of the body 102 of water. The mechanical coupling component 613 can be positioned in the opening 502 to mechanically couple the first curved element 304 and the second curved element 306 to the pile 114. In some examples, the first curved element 304 and the second curved element 306 can be mechanically coupled to the pile 114 for a predetermined amount of time to allow adhesive of the adhesive region 614 to form a bond with the pile 114. In response to coupling the first curved element 304 to the second curved element 306 and to the pile 114, the wave-attenuating disk 112 can be positioned around the pile 114 and on the pile clamp 110 to be suspended from the floor 104 of the body 102 of water.

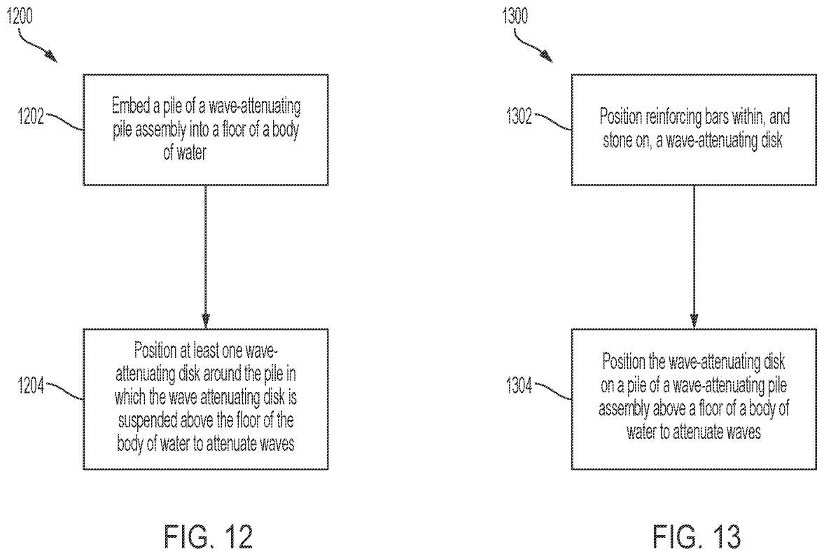

FIG. 12 is a flow chart of a process 1200 to position at least one wave-attenuating disk 112 on a pile 114 of a wave-attenuating pile assembly 300 for attenuating waves 106 according to one example of the present disclosure. At block 1202, a pile 114 of the wave-attenuating pile assembly 300 is embedded in the floor 104 of the body 102 of water. The pile 114 can be embedded a distance 204 into the floor 104 of the body 102 of water, and the distance 204 can be determined in part by an amount of wave energy of the waves 106, by a depth of the body 102 of water, or by other suitable measures.

At block 1204, at least one wave-attenuating disk 112 is positioned around the pile 114 and on a pile clamp 110 for suspending the wave-attenuating disk 112 above the floor 104 of the body 102 of water. In some examples, the bottom wave-attenuating disk 203 may be positioned around the pile 114 and on the upper surface 616 of the pile clamp 110. The wave-attenuating pile assembly 300 may include the bottom wave-attenuating disk 203, but in other examples, in addition to the bottom wave-attenuating disk 203, one or more wave-attenuating disks 112 can be positioned around the pile 114 and on the bottom wave-attenuating disk 203.

FIG. 13 is a flow chart of a process 1300 to attenuate waves 106 of a body 102 of water using a wave-attenuating disk 112 that is suspended above a floor 104 of the body 102 of water according to one example of the present disclosure. At block 1302, reinforcing bars 802 are positioned within, and the stone 310 is positioned on, at least one wave-attenuating disk 112. The reinforcing bars 802 can be positioned within the wave-attenuating disk 112. Additionally or alternatively, the reinforcing bars 802 can be positioned within, and the stone 310 can be positioned on, the bottom wave-attenuating disk 203. In some examples in which the reinforcing bars 802 are positioned within the wave-attenuating disk 112 and within the bottom wave-attenuating disk 203, the reinforcing bars 802 can be positioned in different arrangements within the wave-attenuating disk 112 compared with the bottom wave-attenuating disk 203.

At block 1304, the wave-attenuating disk 112 is positioned around a pile 114 of a wave-attenuating pile assembly 300 to attenuate the waves 106. In some examples, the bottom wave-attenuating disk 203 is positioned on a top or upper surface 616 of the pile clamp 110 that is positioned around the pile 114 for suspending at least one wave-attenuating disk 112 above the floor 104 of the body 102 of water. At least one wave-attenuating disk 112 can, in some examples, be positioned on the bottom wave-attenuating disk 203 for increasing an efficacy or an efficiency of attenuation. In response to being positioned on the pile clamp 110 and around the pile 114, the bottom wave-attenuating disk 203, the wave-attenuating disks 112, or a combination thereof can attenuate, or otherwise reduce energy of, the waves 106 before the waves 106 arrive at the shoreline 108.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A pile clamp comprising:
a first curved element having at least one opening for receiving a mechanical coupling component; and
a second curved element having at least one opening for receiving the mechanical coupling component to couple to the first curved element to the second curved element and to a pile of a wave-attenuating pile assembly to suspend at least one wave-attenuating disk above a floor of a body of water.

2. The pile clamp of claim 1, wherein the first curved element and the second curved element comprise an upper surface, wherein the upper surface is a ring characterized by an inner diameter and an outer diameter, wherein the outer diameter is greater than an inner diameter of the at least one wave-attenuating disk, and wherein the at least one wave-attenuating disk is positionable on top of the upper surface to be suspended above the floor of the body of water.

3. The pile clamp of claim 2, wherein the inner diameter conforms to an outer diameter of the pile of the wave-attenuating pile assembly.

4. The pile clamp of claim 1, further comprising an adhesive positionable on an inner diameter of the first curved element and on an inner diameter of the second curved element for adhesively coupling the first curved element and the second curved element to the pile of the wave-attenuating pile assembly.

5. The pile clamp of claim 4, wherein the adhesive is a two-part marine epoxy, and wherein the mechanical coupling component is operable to couple the first curved element and the second curved element to the pile of the wave-attenuating pile assembly for a predetermined amount of time to allow the adhesive to form a bond between the first curved element and the pile and between the second curved element and the pile.

6. The pile clamp of claim 1, wherein each of the first curved element and the second curved element comprise:
a first ring having a first outer diameter;
a second ring having a second outer diameter, wherein the second outer diameter is less than the first outer diameter;
a tapered region positioned between the first ring and the second ring, wherein the tapered region is characterized by a constant decreasing outer diameter from the first ring to the second ring, wherein a maximum outer diameter of the tapered region is positioned abutting the first ring and a minimum outer diameter of the tapered region is positioned abutting the second ring, and wherein the first ring, the second ring, and the tapered region are characterized by a uniform inner diameter; and
at least two wings that include the at least one opening, wherein the at least two wings are positioned adjacent the first ring, the second ring, and the tapered region, wherein a width of the at least two wings is constant along a first portion of the at least two wings that abuts the second ring, wherein the at least two wings are characterized by a constant decreasing width, from the second ring to the first ring, along a second portion of the at least two wings that abuts the tapered region, wherein the at least two wings and the second ring form a right angle, and wherein the at least two wings and the tapered region form a right angle.

7. The pile clamp of claim 1, wherein the first curved element and the second curved element comprise glass-fiber-reinforced thermosetting resin material.

8. A method comprising:
positioning a first curved element of a pile clamp that includes at least one opening and a second curved element of the pile clamp that includes at least one opening around a pile of a wave-attenuating pile assembly, the first curved element abutting the second curved element, and the first curved element and the second curved element abutting the pile; and
coupling, mechanically, the first curved element to the second curved element and to the pile using a mechanical coupling component positioned within the at least one opening for suspending at least one wave-attenuating disk of the wave-attenuating pile assembly above a floor of a body of water.

9. The method of claim 8, wherein the first curved element and the second curved element comprise an upper surface, wherein the upper surface is a ring characterized by an inner diameter and an outer diameter, wherein the outer diameter is greater than an inner diameter of the at least one wave-attenuating disk, and wherein coupling the first curved element to the second curved element and to the pile includes positioning the at least one wave-attenuating disk on top of the upper surface to be suspended above the floor of the body of water.

10. The method of claim 9, wherein the inner diameter conforms to an outer diameter of the pile of the wave-attenuating pile assembly.

11. The method of claim 8, further comprising positioning an adhesive on an inner diameter of the first curved element and on an inner diameter of the second curved element for adhesively coupling the first curved element and the second curved element to the pile of the wave-attenuating pile assembly.

12. The method of claim 11, wherein the adhesive is a two-part marine epoxy, and wherein coupling the first curved element to the second curved element and to the pile includes coupling, using the mechanical coupling component, the first curved element and the second curved element to the pile of the wave-attenuating pile assembly for a predetermined amount of time to allow the adhesive to form a bond between the first curved element and the pile and between the second curved element and the pile.

13. The method of claim 8, wherein each of the first curved element and the second curved element comprise:
a first ring having a first outer diameter;
a second ring having a second outer diameter, wherein the second outer diameter is less than the first outer diameter;
a tapered region positioned between the first ring and the second ring, wherein the tapered region is characterized by a constant decreasing outer diameter from the first ring to the second ring, wherein a maximum outer diameter of the tapered region is positioned abutting the first ring and a minimum outer diameter of the tapered region is positioned abutting the second ring, and wherein the first ring, the second ring, and the tapered region are characterized by a uniform inner diameter; and
at least two wings that include the at least one opening, wherein the at least two wings are positioned adjacent the first ring, the second ring, and the tapered region, wherein a width of the at least two wings is constant along a first portion of the at least two wings that abuts the second ring, wherein the at least two wings are characterized by a constant decreasing width, from the second ring to the first ring, along a second portion of the at least two wings that abuts the tapered region, wherein the at least two wings and the second ring form a right angle, and wherein the at least two wings and the tapered region form a right angle.

14. The method of claim 8, wherein the first curved element and the second curved element comprise glass-fiber-reinforced thermosetting resin material.

15. A pile system comprising:
a pile positionable in a body of water;
at least one wave-attenuating disk positionable around the pile; and
a pile clamp positionable around the pile, the pile clamp comprising:
a first curved element having at least one opening for receiving a mechanical coupling component; and
a second curved element having at least one opening for receiving the mechanical coupling component to couple the first curved element to the second curved element and to the pile to suspend the at least one wave-attenuating disk above a floor of a body of water.

16. The pile system of claim 15, wherein the first curved element and the second curved element comprise an upper surface, wherein the upper surface is a ring characterized by an inner diameter and an outer diameter, wherein the outer diameter is greater than an inner diameter of the at least one wave-attenuating disk, and wherein the at least one wave-attenuating disk is positionable on top of the upper surface to be suspended above the floor of the body of water.

17. The pile system of claim 16, wherein the inner diameter conforms to an outer diameter of the pile.

18. The pile system of claim 15, further comprising an adhesive positioned on an inner diameter of the first curved element and on an inner diameter of the second curved element for adhesively coupling the first curved element and the second curved element to the pile, wherein the adhesive is a two-part marine epoxy, and wherein the mechanical coupling component couples the first curved element and the second curved element to the pile for a predetermined amount of time to allow the adhesive to form a bond between the first curved element and the pile and between the second curved element and the pile.

19. The pile system of claim 15, wherein each of the first curved element and the second curved element comprise:
a first ring having a first outer diameter;
a second ring having a second outer diameter, wherein the second outer diameter is less than the first outer diameter;
a tapered region positioned between the first ring and the second ring, wherein the tapered region is characterized by a constant decreasing outer diameter from the first ring to the second ring, wherein a maximum outer diameter of the tapered region is positioned abutting the first ring and a minimum outer diameter of the tapered region is positioned abutting the second ring, and wherein the first ring, the second ring, and the tapered region are characterized by a uniform inner diameter; and
at least two wings that include the at least one opening, wherein the at least two wings are positioned adjacent the first ring, the second ring, and the tapered region, wherein a width of the at least two wings is constant along a first portion of the at least two wings that abuts the second ring, wherein the at least two wings are characterized by a constant decreasing width, from the second ring to the first ring, along a second portion of the at least two wings that abuts the tapered region, wherein the at least two wings and the second ring form a right angle, and wherein the at least two wings and the tapered region form a right angle.

20. The pile system of claim 15, wherein the first curved element and the second curved element comprise glass-fiber-reinforced thermosetting resin material.
